(19) United States
(12) Patent Application Publication
(10) Pub. No.: US 2023/0041353 A1
(43) Pub. Date: Feb. 9, 2023

(54) VARIABLE WIDTH FENCE ENTRY

(71) Applicant: Southern Duval Construction, LLC, Corpus Christi, TX (US)

(72) Inventor: Roel BASALDUA, Concepcion, TX (US)

(21) Appl. No.: 17/817,473

(22) Filed: Aug. 4, 2022

Related U.S. Application Data
(60) Provisional application No. 63/229,689, filed on Aug. 5, 2021.

(51) Int. Cl. A01K 1/00; A01K 3/00

(52) U.S. Cl. CPC A01K 1/0023; A01K 3/002

(57) ABSTRACT

A variable width fence entry system can include a detachable extension, and a pivotable connection between the detachable extension and a ground anchor or a cattle guard. The detachable extension is releasably secured to the ground anchor or the cattle guard. A method can include releasably securing a detachable extension to a ground anchor or a cattle guard, and releasably securing the detachable extension to a fence. Another variable width fence entry system can include a detachable extension including at least three pipes arranged in a triangular configuration, and a pivotable connection configured to pivotably connect the detachable extension to a ground anchor or a cattle guard, the pivotable connection including at least two pivot sleeves encircling one of the pipes, and the pivot sleeves being configured to releasably attach to the ground anchor or the cattle guard.

### CROSS-REFERENCE TO RELATED APPLICATION

This application claims the benefit of the filing date of U.S. provisional application No. 63/229,689 filed on Aug. 5, 2021. The entire disclosure of this prior application is incorporated herein by this reference.

### BACKGROUND

This disclosure relates generally to equipment utilized and operations performed in conjunction with fence entries and, in an example described below, more particularly provides a variable width fence entry.

A fence entry permits ingress to, and egress from, a fenced property. Frequently, a fence entry will include a cattle guard to prevent livestock from passing through the fence entry. Typically, a fence entry has a fixed width.

It will be appreciated that improvements are continually needed in the art of constructing and utilizing fence entries. The disclosure below provides such improvements to the art, which may be used with fence entries having cattle guards, and with fence entries not having cattle guards.

### BRIEF DESCRIPTION OF THE DRAWINGS

FIG. 1 is a representative elevational view of an example of a variable width fence entry system and associated method which can embody principles of this disclosure.

FIG. 2 is a representative elevational view of an example of a detachable extension and pivot connections that may be used with the system and method of FIG. 1.

FIG. 3 is a representative side elevational view of the detachable extension and pivot connection.

FIG. 4 is a representative side elevational view of the detachable extension and pivot connection secured to a cattle guard.

FIG. 5 is a representative partially cross-sectional view of the detachable extension and pivot connection secured to a ground anchor.

FIG. 6 is a representative perspective view of another example of the detachable extension and pivot connections secured to a cattle guard.

FIG. 7 is a representative perspective view of another example of the detachable extension and pivot connections secured to a cattle guard.

FIG. 8 is a representative perspective view of another example of the detachable extension and pivot connections secured with a cattle guard and fence.

FIG. 9 is a representative perspective view of a releasable connection between the detachable extension and the fence.

FIG. 10 is a representative elevational view of another example of the fence entry system.

FIG. 11 is a representative perspective view of another example of the detachable extension and pivot connections.

### DETAILED DESCRIPTION

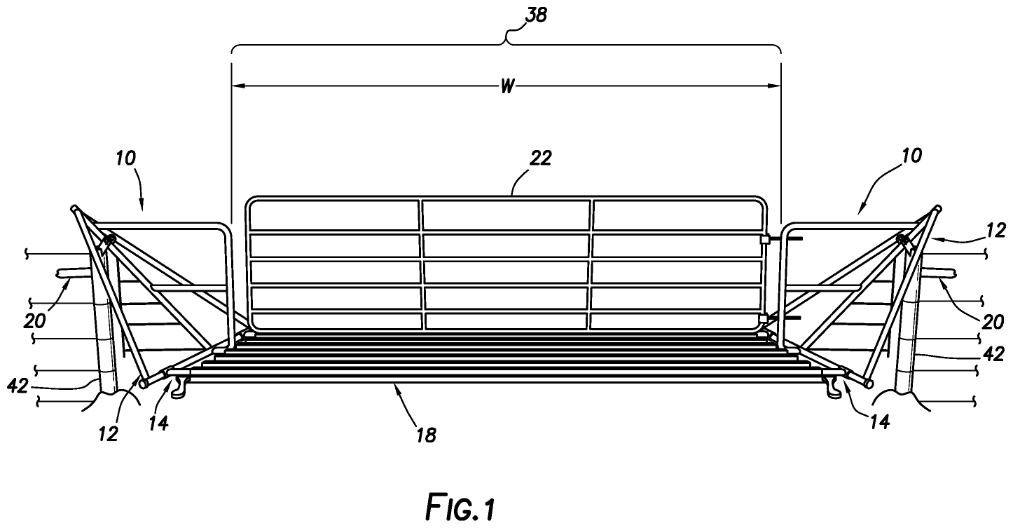

Representatively illustrated in FIG. 1 is a variable width fence entry system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a fence entry system 10 is installed at each opposite end of a gate 22 that temporarily blocks a fence entry 38. The gate 22 is pivotably attached to one of the fence entry systems 10.

As depicted in FIG. 1, the fence entry 38 has a width W so that, when the gate 22 is opened, a vehicle or other structure having a width smaller than the fence entry width W can pass through the fence entry 38. However, using the fence entry system 10 as described more fully below, the width W of the fence entry 38 can be substantially increased, for example, when it is desired for a larger width vehicle or other structure to pass through the fence entry 38.

In this manner, a fence 20 extending on opposite sides of the fence entry 38 does not have to be modified (such as, by removing one or more fence posts 42 of the fence 20) when it is desired to pass a larger width vehicle or structure through the fence entry. In addition, after the larger width vehicle or structure has successfully passed through the increased width fence entry 38, the fence entry system 10 can be conveniently re-installed, so that the width W is restored as depicted in FIG. 1.

In the FIG. 1 example, each of the fence entry systems 10 includes a detachable extension 12. A pivotable connection 14 pivotably and releasably secures the detachable extension 12 to a lateral end of a cattle guard 18. The detachable extension 10 can also be releasably secured to the fence post 42 at each opposite side of the fence entry 38.

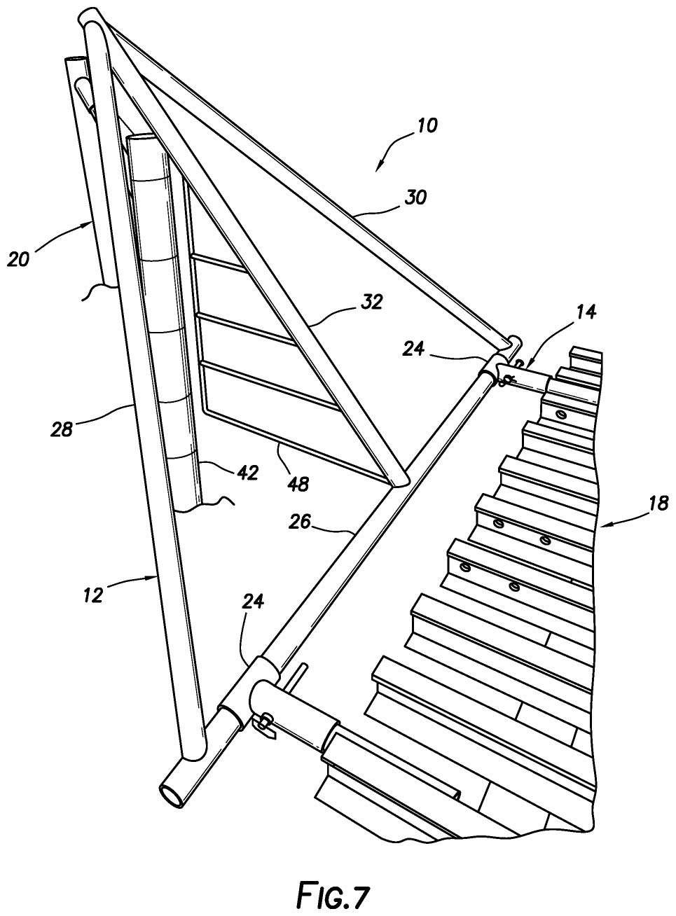

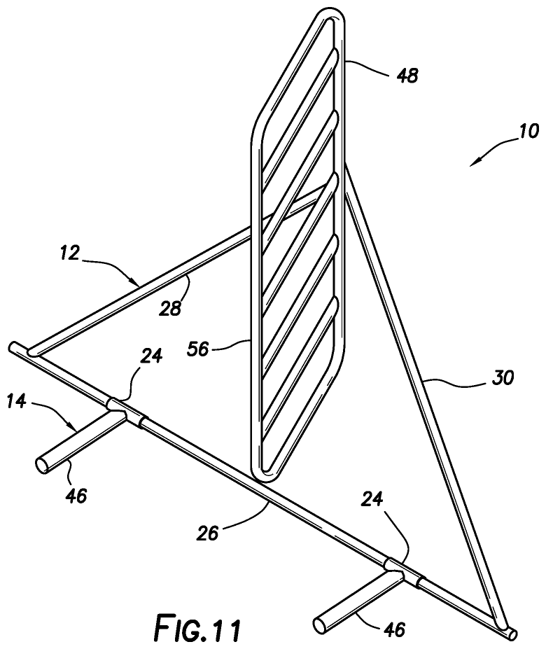

Note that it is not necessary for the detachable extension 12 to be secured to a cattle guard, or for there to be a detachable extension secured at both opposite sides of the fence entry 38. In other examples, the detachable extension 12 may not be secured to a cattle guard (see FIG. 5), or there may be only one detachable extension secured at one side of the fence entry 38 (see FIG. 10).

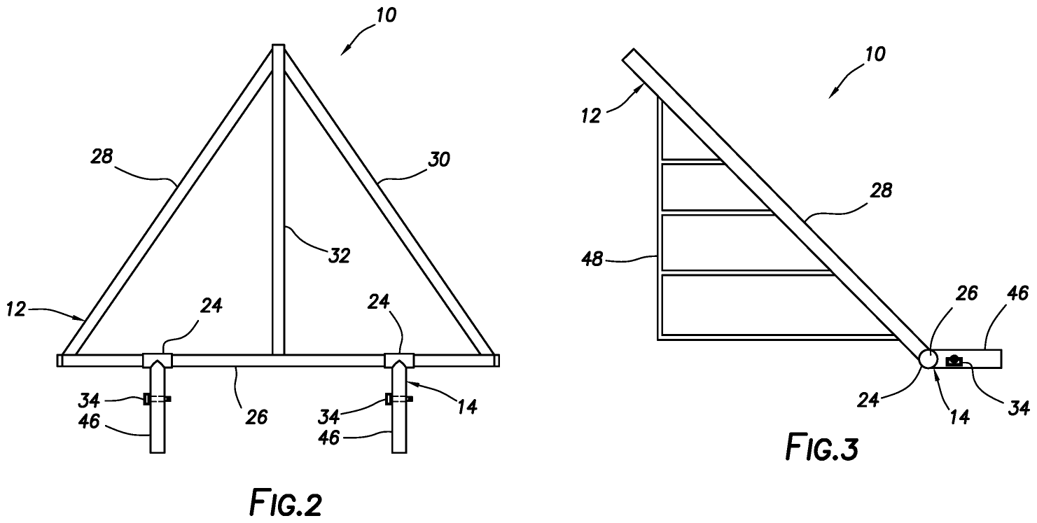

Referring additionally now to FIG. 2, an example of the fence entry system 10 is representatively illustrated. The system 10 is depicted in FIG. 2 prior to installation of the system at a fence entry.

In the FIG. 2 example, the detachable extension 12 is constructed with pipes 26, 28, 30 arranged in a triangle configuration. Preferably, welding is used to permanently connect ends of the pipes 26, 28, 30 to each other at vertices of the triangle, but other fastening means (such as, releasable fasteners) may be used if desired. In addition, it is not necessary for pipes to be used to construct the detachable extension 12, since angle iron or other structural materials or shapes may be used if desired.

The FIG. 2 detachable extension 12 also includes a pipe 32 connected between approximately a middle of the pipe 26 and a vertex of the pipes 28, 30 connection. As described more fully below, the pipe 32 provides additional strength to the detachable extension 12, and also provides a convenient location for a releasable attachment of the detachable extension to the fence post 42.

The pivotable connection 14 in the FIG. 2 example includes two pivot sleeves 24 installed on the pipe 26 on opposite sides of the pipe 32. The pipe 26 is received in the pivot sleeves 24, so that relative rotation is permitted between the pipe 26 and the pivot sleeves 24. For example, a pivot sleeve 24 could comprise a cylindrical tube having an inner diameter that is greater than an outer diameter of the pipe 26. Other types of pivotable connections (such as, hinges, etc.) may be used in other examples.

A pipe 46 is connected to each pivot sleeve 24 (such as, by welding) and extends outwardly from the pivot sleeve. A pin 34 can be installed in holes in the pipe 46, in order to releasably attach the detachable extension 12 to another structure (such as, the cattle guard 18), as described more fully below.

It is not necessary for two pivot sleeves 24 to be used in the pivotable connection 14, since any other number (including one) may be used in other examples. Releasable fasteners other than pins 34 may also be used. Thus, it should be clearly understood that the scope of this disclosure is not limited to any particular construction, arrangement or component of the detachable extension 12 or the pivotable connection 14 as described herein or depicted in the drawings.

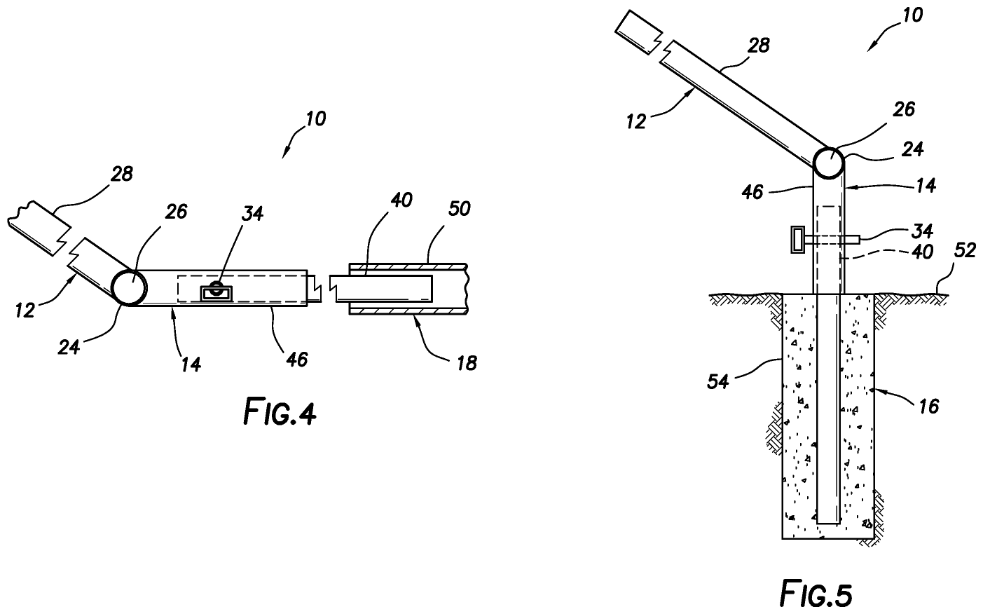

Referring additionally now to FIG. 3, a side view of the fence entry system 10 is representatively illustrated. In this view it may be seen that a fence-type closure 48 is included with the detachable extension 12.

The closure 48 prevents access through a space formed between the pipes 26, 28, 30, 32 and the nearest fence post 42. In the FIG. 3 example, the closure 48 is triangular in shape, but other shapes may be used in other examples.

The closure 48 is connected to the pipe 32 and extends downward therefrom in this example. In other examples, the closure 48 could be connected to other components of the detachable extension 12, or the closure could extend upward (see FIG. 10), or both upward and downward (see FIG. 11). In other examples (such as, when there is no need to prevent livestock from passing through the fence entry 38), the closure 48 may not be used.

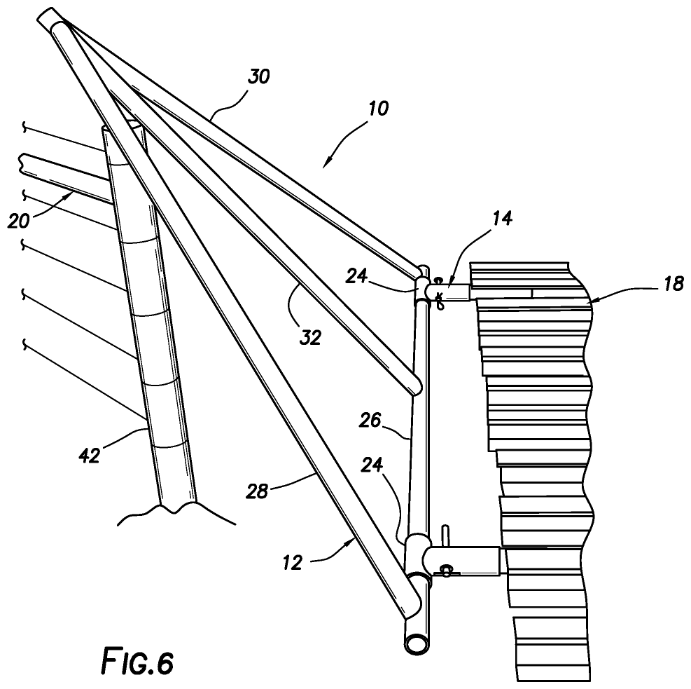

Referring additionally now to FIG. 4, an example of a releasable attachment of the fence entry system 10 to a lateral end of a cattle guard 18 is representatively illustrated. In this example, each of the pipes 46 of the pivotable connection 14 is releasably secured to the cattle guard 18 using a pin 34.

The cattle guard 18 is modified somewhat to accept the pivotable connection 14. Specifically, a pipe 40 is connected to a laterally extending rail 50 of the cattle guard 18 (such as, by welding or fastening), so that the pipe 40 extends laterally outward from the end of the cattle guard 18.

The pipe 40 is sized, so that it can be received in the pipe 46 of the pivotable connection 14. For example, the pipe 40 can have an outer diameter that is less than an inner diameter of the pipe 46. The pipe 40 is provided with holes to receive the pin 34 therein.

Thus, after the cattle guard 18 has been modified to include the pipe 40 extending outward therefrom, the fence entry system 10 can be conveniently secured to the cattle guard by sliding the pipe 46 over the pipe 40, aligning the holes in the pipes, and then installing the pin 34 through the aligned holes. Due to the pivotable connection 14, the detachable extension 12 can then be rotated relative to the cattle guard 18 while the system 10 is releasably secured to the cattle guard.

When it is desired to detach the fence entry system 10 from the cattle guard 18, the pin 34 can be removed and the pipe 46 can then be slid off of the pipe 40. The ability to rotate the detachable extension 12 relative to the cattle guard 18 facilitates the installation and removal of the fence entry system 10 between the cattle guard and the fence post 42. When the system 10 is removed, the width W of the fence entry 38 is thereby increased.

Referring additionally now to FIG. 5, another example of the system 10 is representatively illustrated. In this example, the system 10 is not secured to a cattle guard, but is instead releasably and pivotably secured to a ground anchor 16.

As depicted in FIG. 5, the ground anchor 16 includes the pipe 40 secured in the ground 52 with a mass of concrete 54. The ground anchor 16 provides a rigid attachment point for the pivotable connection 14. Any number of ground anchors 16 may be used as desired. The ground anchor(s) 16 are positioned at opposite sides of the fence entry 38.

After the pipe 40 has been secured in the ground 52 with the concrete 54, the fence entry system 10 can be conveniently secured to the ground anchor 16 by sliding the pipe 46 over the pipe 40, aligning the holes in the pipes, and then installing the pin 34 through the aligned holes. Due to the pivotable connection 14, the detachable extension 12 can then be rotated relative to the ground anchor 16 while the system 10 is releasably secured to the ground anchor.

When it is desired to detach the fence entry system 10 from the ground anchor 16, the pin 34 can be removed and the pipe 46 can then be slid off of the pipe 40. The ability to rotate the detachable extension 12 relative to the ground anchor 16 facilitates the installation and removal of the fence entry system 10 between the ground anchor and the fence post 42. When the system 10 is removed, the width W of the fence entry 38 is thereby increased.

Referring additionally now to FIGS. 6-8, various examples of the system 10 having different features are representatively illustrated. These examples demonstrate that the scope of this disclosure is not limited to the details of any particular system 10 example described herein or depicted in the drawings.

In the FIG. 6 example, the pivotable connection 14 is releasably secured to an end of the cattle guard 18 in a manner substantially similar to that depicted in FIG. 4. With the detachable extension 12 thereby pivotably connected to the cattle guard 18, the pipe 32 can rest on the fence post 42, so that the detachable extension extends between the fence post and the cattle guard.

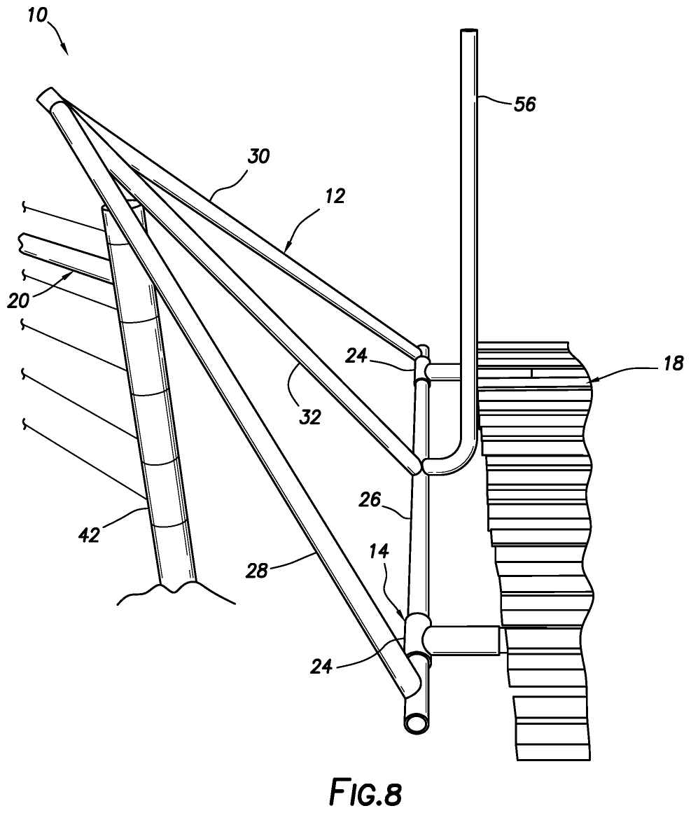

In the FIG. 7 example, the system 10 is connected between the cattle guard 18 and the fence post 42, as in the FIG. 6 example. In addition, a space between the detachable extension 12 and the fence post 42 is blocked by the closure 48, which extends downward from the pipe 32.

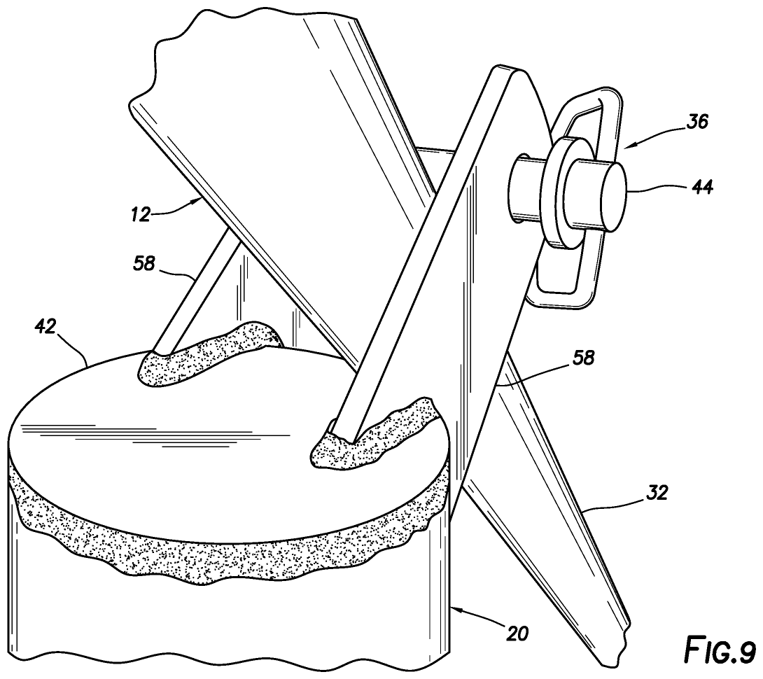

In the FIG. 8 example, a gate post 56 is connected to the pipe 26 and extends upward therefrom. The gate post 56 may be used to pivotably attach a gate 22 to the detachable extension 12 (as depicted in FIG. 1). A closure may be used to block access through a space formed between the gate post 56 and the pipe 32. A height of the gate post 56 can be selected to match any height of the fence 20 or gate 22.

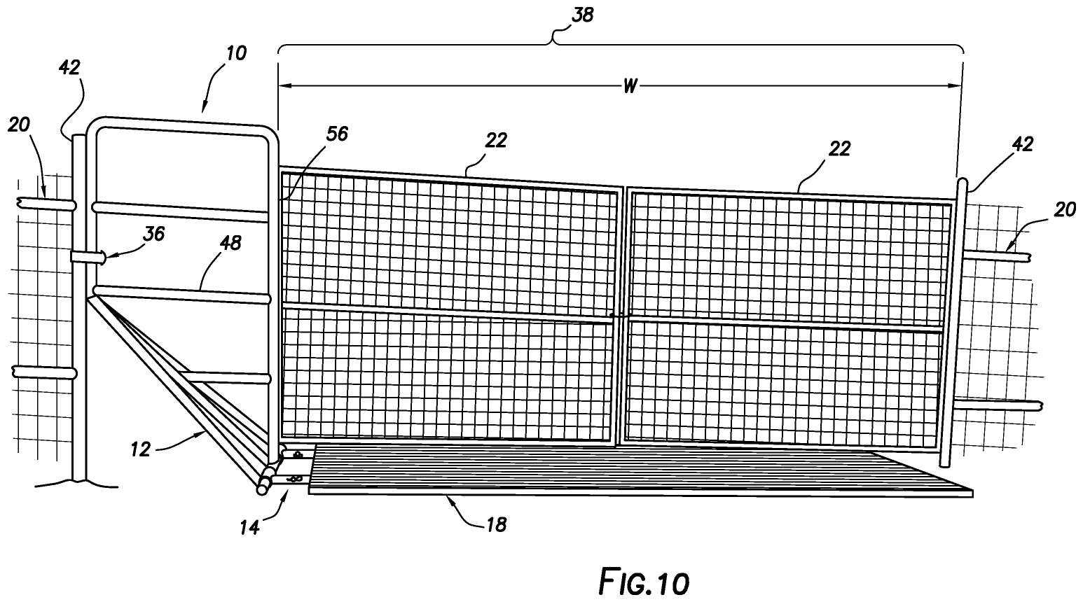

Referring additionally now to FIG. 9, an example of a releasable connection 36 between the detachable extension 12 and the fence post 42 is representatively illustrated. In the FIG. 9 example, the pipe 32 is releasably secured to the fence post 42, but in other examples one or more other components of the detachable extension 12 (such as, upper ends of the pipes 28, 30) may be releasably secured to the fence post.

As depicted in FIG. 9, two tabs 58 are welded to the fence post 42, so that the pipe 32 can be positioned between the tabs. A pin 44 (or other type of releasable fastener) is installed through holes in the tabs 58, thereby capturing the pipe 32 between the pin and the fence post 42.

When it is desired to remove the detachable extension 12, the pin 44 can be withdrawn from the holes in the tabs 58, thereby releasing the pipe 32 from the fence post 42. At that point, the detachable extension 12 can be pivoted upward from the fence post 42 and the pivotable connection 14 can be released from the cattle guard 18 or the ground anchor 16.

Referring additionally now to FIG. 10, another example of the fence entry system 10 is representatively illustrated. In this example, only one fence entry system 10 is used at one side of the fence entry 38.

In addition, a gate post 56 is used to pivotably attach a gate 22 to the detachable extension 12. The gate post 56 forms an inner side of a closure 48 that extends upward from the detachable extension 12. Wire fencing is used in this example to prevent access through any remaining spaces formed between the detachable extension 12 and the fence 20, or between components of the fence entry system 10.

Referring additionally now to FIG. 11, another example of the fence entry system 10 is representatively illustrated. In this example, the detachable extension 12 includes a closure 48 that extends both upward and downward. An inner pipe of the closure 48 can function as a gate post 56. Note that the pipe 32 is not used in the FIG. 11 detachable extension 12.

It may now be fully appreciated that the above disclosure provides significant advancements to the art of constructing and utilizing fence entries. In various examples described herein, the fence entry system 10 is conveniently installed at, or removed from, an end of the fence entry 38 to thereby respectively decrease or increase the width W of the fence entry. The pivotable connection 14 allows the detachable extension 12 to rotate while it is releasably secured to the cattle guard 18, the ground anchor 16 or another rigid support.

The above disclosure provides to the art a variable width fence entry system 10. In one example, the system 10 can include at least one detachable extension 12; and a pivotable connection 14 between the detachable extension 12 and a ground anchor 16 and/or a cattle guard 18. The detachable extension 12 is releasably secured to the ground anchor 16 or the cattle guard 18.

The detachable extension 12 may be configured to connect between a fence 20 and the ground anchor 16 or the cattle guard 18. A gate 22 may be pivotably attached to the detachable extension 12.

A pivot sleeve 24 of the pivotable connection 14 may be releasably attached to the ground anchor 16 or the cattle guard 18. The pivot sleeve 24 may surround a pipe 26 of the detachable extension 12. A pin 34 may releasably secure the pivot sleeve 24 to a pipe 40 of the ground anchor 16 or the cattle guard 18.

The detachable extension 12 may comprise at least first, second and third pipes 26, 28, 30 arranged in a triangular configuration. At least two pivot sleeves 24 of the pivotable connection 14 may encircle the first pipe 26. A releasable connection 36 may be configured to connect a fence 20 to the second and third pipes 28, 30.

A method is also provided to the art by the above disclosure. In one example, the method can comprise: releasably securing a detachable extension 12 to a ground anchor 16 and/or a cattle guard 18; and releasably securing the detachable extension 12 to a fence 20.

The method may include releasing the detachable extension 12 from the fence 20 and the ground anchor 16 or the cattle guard 18, thereby increasing a width W of a fence entry 38.

The step of releasably securing the detachable extension 12 to the ground anchor 16 or the cattle guard 18 may include releasably securing a pivot sleeve 24 to a pipe 40 of the ground anchor 16 or the cattle guard 18.

The step of releasably securing the pivot sleeve 24 may include inserting a pin 34 into the pivot sleeve 24 and the pipe 40. The pivot sleeve 24 may encircle a pipe 26 of the detachable extension 12.

The step of releasably securing the detachable extension 12 to the fence 20 may include positioning a pipe 32 of the detachable extension 12 between the fence 20 and a pin 44. The pipe 32 is releasable from the fence 20 when the pin 44 is removed.

The method may include pivotably attaching a gate 22 to the detachable extension 12.

Another variable width fence entry system 10 described above can comprise: a detachable extension 12 including at least first, second and third pipes 26, 28, 30 arranged in a triangular configuration; and a pivotable connection 14 configured to pivotably connect the detachable extension 12 to a ground anchor 16 and/or a cattle guard 18. In this example, the pivotable connection 14 includes at least two pivot sleeves 24 encircling the first pipe 26. The pivot sleeves 24 are configured to releasably attach to the ground anchor 16 or the cattle guard 18.

The detachable extension 12 may be configured to connect between a fence 20 and the ground anchor 16 or the cattle guard 18. A gate 22 may be pivotably attached to the detachable extension 12.

The detachable extension 12 may include a fourth pipe 32 secured to the first pipe 26 between the pivot sleeves 24. The fourth pipe 32 may be secured to a connection between the second and third pipes 28, 30.

The fourth pipe 32 may be releasably secured to a fence 20. At least two pins 34 may releasably secure the pivot sleeves 24 to the ground anchor 16 or the cattle guard 18.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations and configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A variable width fence entry system, comprising:
at least one detachable extension; and
a pivotable connection between the detachable extension and at least one of the group consisting of a ground anchor and a cattle guard,
in which the detachable extension is releasably secured to the at least one of the group consisting of the ground anchor and the cattle guard.

2. The variable width fence entry system of claim 1, in which the detachable extension is configured to connect between a fence and the at least one of the group consisting of the ground anchor and the cattle guard.

3. The variable width fence entry system of claim 1, in which a gate is pivotably attached to the detachable extension.

4. The variable width fence entry system of claim 1, in which a pivot sleeve of the pivotable connection is releasably attached to the at least one of the group consisting of the ground anchor and the cattle guard.

5. The variable width fence entry system of claim 4, in which the pivot sleeve surrounds a pipe of the detachable extension.

6. The variable width fence entry system of claim 4, in which a pin releasably secures the pivot sleeve to a pipe of the at least one of the group consisting of the ground anchor and the cattle guard.

7. The variable width fence entry system of claim 1, in which the detachable extension comprises at least first, second and third pipes arranged in a triangular configuration, at least two pivot sleeves of the pivotable connection encircling the first pipe, and a releasable connection configured to connect a fence to the second and third pipes.

8. A method, comprising:
releasably securing a detachable extension to at least one of the group consisting of a ground anchor and a cattle guard; and
releasably securing the detachable extension to a fence.

9. The method of claim 8, further comprising releasing the detachable extension from the fence and the at least one of the group consisting of the ground anchor and the cattle guard, thereby increasing a width of a fence entry.

10. The method of claim 8, in which the step of releasably securing the detachable extension to the at least one of the group consisting of the ground anchor and the cattle guard comprises releasably securing a pivot sleeve to a pipe of the at least one of the group consisting of the ground anchor and the cattle guard.

11. The method of claim 10, in which the step of releasably securing the pivot sleeve comprises inserting a pin into the pivot sleeve and the pipe.

12. The method of claim 10, in which the pivot sleeve encircles a pipe of the detachable extension.

13. The method of claim 8, in which the step of releasably securing the detachable extension to the fence comprises positioning a pipe of the detachable extension between the fence and a pin, whereby the pipe is releasable from the fence when the pin is removed.

14. The method of claim 8, further comprising pivotably attaching a gate to the detachable extension.

15. A variable width fence entry system, comprising:
a detachable extension including at least first, second and third pipes arranged in a triangular configuration; and
a pivotable connection configured to pivotably connect the detachable extension to at least one of the group consisting of a ground anchor and a cattle guard, the pivotable connection including at least two pivot sleeves encircling the first pipe, and the pivot sleeves being configured to releasably attach to the at least one of the group consisting of the ground anchor and the cattle guard.

16. The variable width fence entry system of claim 15, in which the detachable extension is configured to connect between a fence and the at least one of the group consisting of the ground anchor and the cattle guard.

17. The variable width fence entry system of claim 15, in which a gate is pivotably attached to the detachable extension.

18. The variable width fence entry system of claim 15, in which the detachable extension further includes a fourth pipe secured to the first pipe between the pivot sleeves, and the fourth pipe secured to a connection between the second and third pipes.

19. The variable width fence entry system of claim 18, in which the fourth pipe is releasably secured to a fence.

20. The variable width fence entry system of claim 15, in which at least two pins releasably secure the pivot sleeves to the at least one of the group consisting of the ground anchor and the cattle guard.
